(19) United States
(12) Patent Application Publication
(10) Pub. No.: US 2005/0144832 A1
(43) Pub. Date: Jul. 7, 2005

(54) Burrowing rodent extermination device including a remote control panel

(76) Inventor: Joseph Shaffer, Midvale, ID (US)

Correspondence Address: Joseph W. Holland;Holland & Midgley, LLP, P.O. Box 1840, Boise, ID, 83701-1840, US

(21) Appl. No.: 11/064,296

(22) Filed: Feb. 22, 2005

Related U.S. Application Data
(63) Continuation-in-part of application No. 10/959,353.
(60) Provisional application No. 60/509,817, filed on Oct. 8, 2003.

(51) Int. Cl. A01M 17/00

(52) U.S. Cl. 43/124

(57) ABSTRACT

A device and method for controlling a population of burrowing rodents including a remote control panel having a welding torch. The welding torch includes a gas flow valve. A pair of hoses are connected between the welding torch, a bottle of oxygen and a bottle of fuel gas. Another hose having a length greater than 5 feet is connected to a downstream end of the gas flow valve and extends and connects to an injector. An ignition wire extends between an ignition switch and the injector. The hose connecting the welding torch and the injector may be twenty-five feet long. In operation, an operator places a fire cone end of the injector in a hole connected to a tunnel system and then steps back to the remote control panel positioned at a location remote to the fire cone to operate gas flow and ignition of gas in the tunnel.

### RELATED APPLICATIONS

This application is a continuation-in-part of and claims the priority of an application entitled Remote Control Panel, Ser. No. 10/959,353, filed on Oct. 5, 2004, which claims benefit to a provisional application, entitled Remote Control Panel, Ser. No. 60/509,817, filed on Oct. 8, 2003, entitled Remote Control Panel.

### BACKGROUND OF THE INVENTION

The present invention relates generally to devices for the extermination of rodents and more particularly to a device and method for the injection of a flammable gas into a tunnel of a burrowing rodent and the detonation of said gas from a location that is remote to the site of gas injection.

The prior art includes a number of devices that provide for the detonation or ignition of a fuel gas mixture in a burrow or tunnel system of a burrowing rodent. U.S. Pat. No. 6,171,098 to Meyer, et al., entitled Rodent Exterminating Apparatus, U.S. Pat. No. 5,860,243 to Stager entitled Device for Explosive Extermination of Rodents and U.S. Pat. No. 4,005,976 to Rombach, et al., entitled Rodent Exterminator all disclose portable exterminating devices that ignite a gas or gas mixture to produce a detonation of the gas or gas mixture in the burrow or tunnel system of a rodent. All of these devices include a barrel or other means for conducting the gas or gas mixture into the burrow or tunnel system, a gas flow control means for controlling the injection of mixed gas into the burrow or tunnel system and an ignition system positioned adjacent to the gas flow control means on a handle that the operator maintains contact with during detonation.

It has been observed that repeated exposure to the concussion experienced by an operator directly at or above the blast site can cause fatigue in the operator. Additionally, it has been observed, on occasion, that gas can get trapped in the unit and can ignite in these units, giving rise to a potential for injury to the operator and/or the device.

Advantage may be found in providing a device and method for the injection of a flammable gas into a tunnel of a burrowing rodent and the detonation of said gas from a location that is remote to the site of gas injection. There may be advantage in providing a burrowing rodent extermination device wherein the ignition switch, the high voltage emitter and the fuel mixing and flow control means are not all located on a continuous support element, for instance a handle or an amalgamation of parts including a conduit and fuel mixing and flow control means that form a support, handle or carrying means. Therefore, it is an objective of the present invention to provide a device and method for the injection of a flammable gas or gas mixture into a tunnel of a burrowing rodent and ignition switching to effect detonation of said gas from a location that is remote to the site of gas injection and generation and emission of a spark for initiating detonation.

### SUMMARY

The present invention is directed to a device and method for controlling the population of burrowing rodents. A device for controlling the population of burrowing rodents includes a remote control panel including a box having a lid with a welding torch positioned at least partially within the box. The welding torch includes a gas flow valve. A pair of hoses are connected between the welding torch and a bottle of oxygen and a bottle of fuel gas. A hose is connected to a downstream end of the gas flow valve and extends to an injector. An ignition wire extends between an ignition switch and the injector. A high voltage converter is attached to the injector and a spark emitter is positioned in the fire cone end of the injector. An electrical cutout switch is connected between the ignition switch and the gas flow valve and prevents operation of the ignition switch while the gas flow valve is open. The hose connecting the welding torch and the injector may be five to fifty feet, (1.524 to 15.24 meters), long or longer. The injector is equipped with a flash arrestor-check valve, preventing fire from coming back up into the hose.

In operation, an operator places a fire cone end of the injector in a hole connected to a tunnel system and then steps back to the remote control panel to operate gas flow. After gas is injected into a burrow or tunnel system for a selected time, the gas flow valve is closed and the ignition switch is engaged. A low voltage current is switched from a battery located in the remote control panel to the high voltage converter and a spark emits in the fire cone igniting the gas mixture in the tunnel.

The injector, to which the high voltage converter is connected is not held by the operator at the time of ignition and detonation. As a result, the operator and the ignition switch are distanced a length greater than a length of the injector from the high voltage converter and the spark emitter at the time of ignition and therefore the operator is not exposed to the repeated concussion experienced directly at or above the blast site that can cause operator fatigue. Additionally, ignition of gas upstream of the injector or at the location of the operator at the time of ignition is markedly reduced by the fact that the ignition switch and therefore the operator are distanced a length greater than the length of the injector from the high voltage converter and the spark emitter at the time of ignition. The use of a flash arrestor/check valve at the injector also reduces the probability of flash back to the remote control panel.

The high voltage converter generates a high-voltage, low-amperage electrical charge. One or more batteries supply electricity to a circuit including one or more transformers that boost the voltage in the circuit, typically to between 20,000 and 150,000 volts, and reduce the amperage. The high-voltage, low-amperage current charges a capacitor that stores a charge, and releases it when switched.

Additional objects, advantages and novel features of the invention will be set forth in part in the description which follows, and in part will become apparent to those skilled in the art upon examination of the following, or may be learned by practice of the invention. The objects and advantages of the invention may be realized and attained by means of the instrumentalities and combination particularly pointed out in the appended claims.

### DESCRIPTION OF THE DRAWINGS

FIG. 1 is a drawing representing a preferred embodiment of a device for controlling the population of burrowing rodents including a remote control panel.

FIG. 2 is a drawing representing a preferred embodiment of a device for controlling the population of burrowing rodents including a remote control panel.

FIG. 3 is a partial cutaway drawing representing a remote control panel of the preferred embodiment of a device for controlling the population of burrowing rodents.

FIG. 4 is a schematic diagram depicting a circuit for a device for controlling the population of burrowing rodents including a remote control panel.

FIG. 5 is a schematic flow diagram depicting a method for controlling the population of burrowing rodents using a device for controlling the population of burrowing rodents including a remote control panel.

### DESCRIPTION

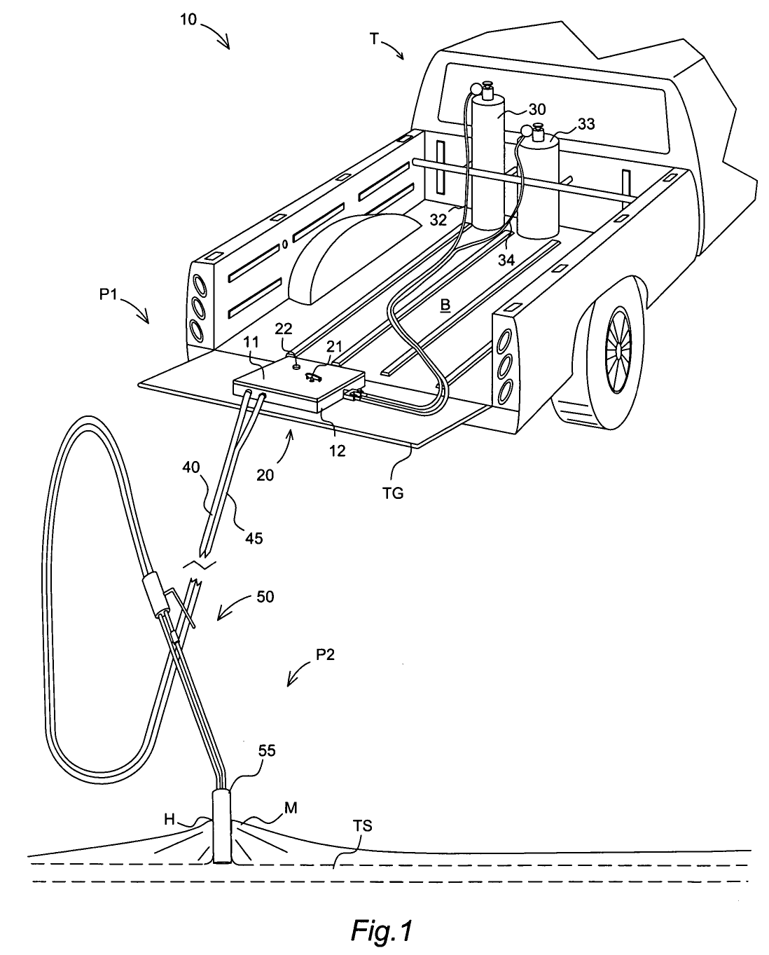

Referring to FIG. 1 a preferred embodiment of a burrowing rodent control device 100 is shown including remote control panel 20 located at position P1 and injector 50 located at position P2 remote to the location position P1. Oxygen tank 30 and fuel gas tank 33 are shown secured in a bed B of pickup T and connected to remote control panel 20 of burrowing rodent control device 10 by first hose 32 and second hose 34. Remote control panel 20 is shown positioned on tailgate TG of pickup T. Third hose 45 and ignition wire 40 are connected to and extend between remote control panel 20 and injector 50. Fire cone 55 of injector 50 is shown positioned in hole H, opened in mound M, connects to tunnel system TS. Ignition switch button 22 and gas flow valve operation lever 21 are accessible and operable through lid 11 of enclosure 12.

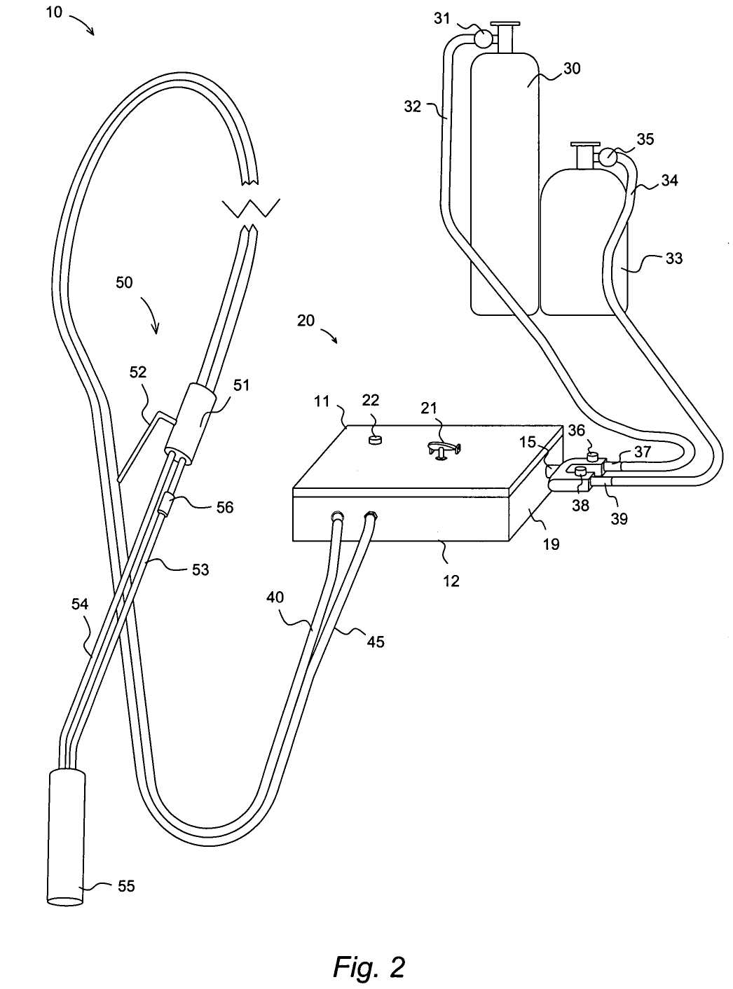

As shown in FIG. 2, oxygen tank 30 and fuel gas tank 33 are shown connected to remote control panel 20 of burrowing rodent control device 10 through regulator 31 and regulator 35 respectively, by first hose 32 and second hose 34. Third hose 45 and ignition wire 40 are connected to and extend between remote control panel 20 and injector 50. Ignition switch button 22 and gas flow valve operation lever 21 are accessible and operable through lid 11 of enclosure 12. Mixing valves 36 and 38 are connected to an upstream end of mixing chamber 15 and extend through an end wall 19 of remote control panel 20. Flash arrestor 37 is positioned between first hose 32 and mixing valve 36. Similarly, flash arrestor 39 is positioned between second hose 34 and mixing valve 38. In a preferred embodiment, gas mixing chamber 15, mixing valve 36, (and mixing valve 38, shown in FIG. 2), are configured as a gas welding torch. Injector 50 includes fire cone 55 and housing 51 to which third hose 45 and ignition wire 40 are connected. As shown in FIG. 2, third hose 45 and ignition wire 40 are “piggybacked” or attached to one another along a substantial portion of their respective lengths for ease of handling. Gas tube 53 and conductor tube 54 extend between fire cone 55 and body 51. Flash arrestor 56 is positioned between in gas tube 53 between fire cone 55 and housing 51. Handel 52 is attached to and extends from housing 51 to provide a means for transporting injector 50.

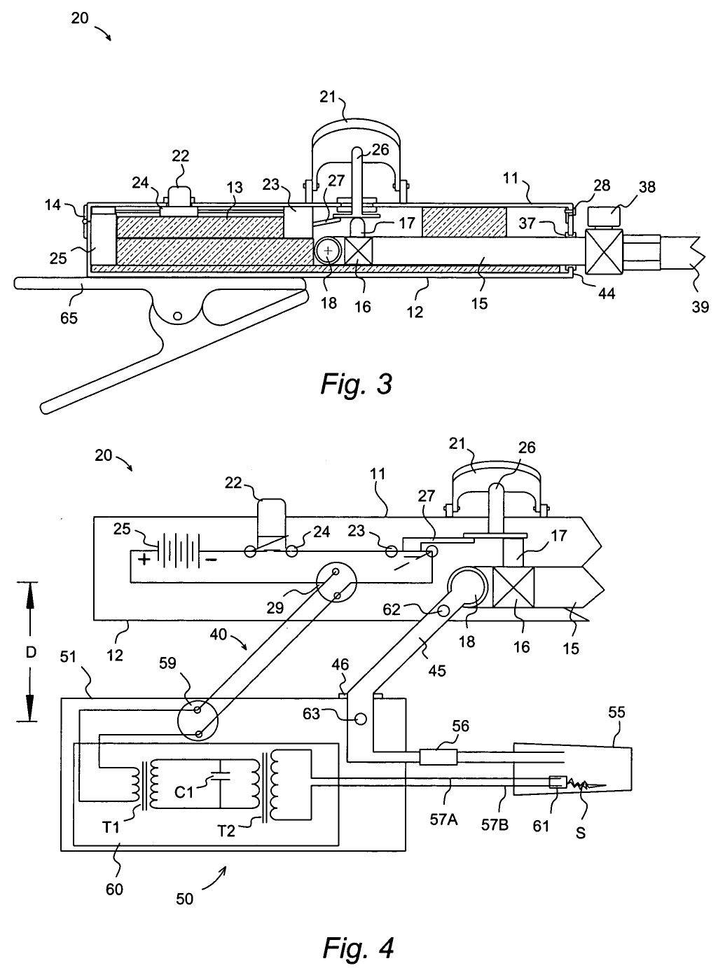

Referring to FIG. 3, remote control panel 20 of burrowing rodent control device 10 is shown in a partial cutaway drawing. Enclosure 12 includes lid 11 shown hingedly attached to enclosure 12 by hinge 14. Screw 28 provides a means for securing lid 11 in a closed position. Remote control panel 20 may include one or more clamps 65 for securing the unit to a surface while in use. Remote control panel 20 includes gas mixing chamber 15 which is fluidly connected between mixing valve 36, (and mixing valve 38, shown in FIG. 2), and gas flow valve 16. Mixing chamber 15 extends through end wall 19 of enclosure 12 at grommet 37 connecting to mixing valve 38. Gas flow valve operation lever 21 is accessible and operable through lid 11 of enclosure 12. A mixture of fuel gas and oxygen are regulated by mixing valve 36, (and mixing valve 38, shown in FIG. 2), mixed in mixing chamber 16 and expelled through outlet 18 when flow control actuator 17 is depressed by gas flow valve operation lever 21. Remote control panel 20 also includes ignition switch 26 operable by ignition switch button 22 and ignition circuit cutout switch 23 operable by trigger 27. Ignition circuit cutout switch 23 is connected to ignition switch 26 and is cooperatively operative with gas flow valve 16. Battery 25 is connected to ignition switch 26. The various components of remote control panel 20 are held in close packed arrangement by foam 13, which is formed suitably about the various components of remote control panel 20.

Referring to FIG. 4, a portion of remote control panel 20 is shown connected to injector 50. Third hose 45 and ignition wire 40 are connected to and extend between remote control panel 20 and injector 50. Ignition wire 40 includes one or more conductors. In the preferred embodiment, ignition wire 40 includes plug-in ends that are accepted in receptacles 29 and 59. In one embodiment of the invention, third hose 45 extends a distance D of 7.62 meters, (25 feet), between remote control panel 20 and injector 50. In one embodiment of the invention, injector 50 may measure approximately 38 inches, (0.96 meters), long. Preferably, third hose 45 and ignition wire 40 will be of a length in the range of 1.5 to 30.5 meters long, (5 to 100 feet long), providing a distance between remote control panel 20 and fire cone 55 in the range of 1.5 to 31.4 meters, (5 to approximately 53 feet long), depending on the length of third hose 45, ignition wire 40 and injector 50. Providing the capability of distancing the operator from the immediate vicinity of the detonation and resulting concussion may reduce and limit fatigue to the operator.

High voltage converter circuit 60 is shown enclosed in housing 51 of injector 50. High voltage converter circuit 60 includes one or more step-up transformers show as transformers T1 and T2 and a capacitor C1 for storing a high voltage low amperage charge. A pair of discharge wires, 57A and 57B, connect to high voltage converter circuit 60 extend to fire cone 55. Flash arrestor 56 is shown positioned downstream of in housing 51 and high voltage converter circuit 60 for limiting the possibility a flashback into housing 51 and high voltage converter circuit 60. In the event that such a flashback were to occur, soft plug 63 located in housing 51 and soft plug 62 located in remote control panel 20 would serve limit damage.

Gas flow valve 16 is biased towards a closed position. Plunger 26 is positioned between gas flow valve operation lever 21 and gas flow valve actuator 17. Gas flow valve operation lever 21 is connected to lid 11 of enclosure 12 and is cooperatively operative with a flow control actuator via plunger 26. Plunger 26 includes a flange 46 that is adapted to contact flow valve actuator 17 and trigger 27 of ignition circuit cutout switch 23 when gas flow valve operation lever 21 is depressed. When trigger 27 of ignition circuit cutout switch 23 is depressed the ignition circuit is broken and therefore inoperable. When pressure on plunger 26 and gas flow valve actuator 17 are released through outlet 18 of mining chamber 15, gas flow valve 16 returns to a closed position, trigger 27 is released and ignition circuit cutout switch 23 returns to a close position. Ignition of the mixed gas is now possible by pressing ignition switch button 22 of ignition switch 24 which triggers the emission of spark S at emitter 61 located in fire cone 55. Battery 25 provides the low voltage current for the circuit. As high voltage converter circuit 60 is located in housing 51 of injector 50, the possibility of a spark in remote control panel 20 becomes greatly diminished.

In use, a pressurized flow of a controlled ratio of fuel gas, preferably propane, and oxygen, is injected for a specific amount of time, 30-60 seconds, into tunnel system TS depending on type of pest and tunnel conditions. Button 22 of ignition switch 26 is pushed and the ensuing explosion kills pests in the tunnel system by concussion, burying them at the same time. The explosion follows the route of the tunnel system and does no damage except to that system.

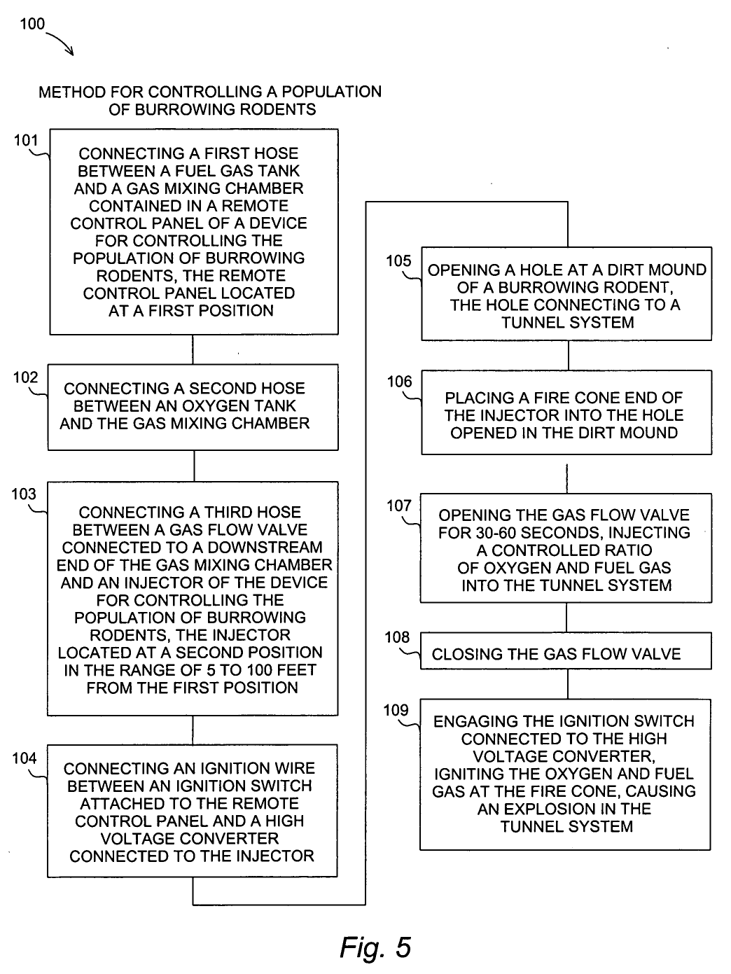

FIG. 5 shows a METHOD FOR CONTROLLING A POPULATION OF BURROWING RODENTS 100 including the steps of: CONNECTING A FIRST HOSE BETWEEN A FUEL GAS TANK AND A GAS MIXING CHAMBER CONTAINED IN A REMOTE CONTROL PANEL OF A DEVICE FOR CONTROLLING THE POPULATION OF BURROWING RODENTS, THE REMOTE CONTROL PANEL LOCATED AT A FIRST POSITION 101, CONNECTING A SECOND HOSE BETWEEN AN OXYGEN TANK AND THE GAS MIXING CHAMBER 102, CONNECTING A THIRD HOSE BETWEEN A GAS FLOW VALVE CONNECTED TO A DOWNSTREAM END OF THE GAS MIXING CHAMBER AND AN INJECTOR OF THE DEVICE FOR CONTROLLING THE POPULATION OF BURROWING RODENTS, THE INJECTOR LOCATED AT A SECOND POSITION IN THE RANGE OF 5 TO 100 FEET FROM THE FIRST POSITION 103, CONNECTING AN IGNITION WIRE BETWEEN AN IGNITION SWITCH ATTACHED TO THE REMOTE CONTROL PANEL AND A HIGH VOLTAGE CONVERTER CONNECTED TO THE INJECTOR 104, OPENING A HOLE AT A DIRT MOUND OF A BURROWING RODENT, THE HOLE CONNECTING TO A TUNNEL SYSTEM 105, PLACING A FIRE CONE END OF THE INJECTOR INTO THE HOLE OPENED IN THE DIRT MOUND 106, OPENING THE GAS FLOW VALVE FOR 30-60 SECONDS, INJECTING A CONTROLLED RATIO OF OXYGEN AND FUEL GAS INTO THE TUNNEL SYSTEM 107, CLOSING THE GAS FLOW VALVE 108 and ENGAGING THE IGNITION SWITCH CONNECTED TO THE HIGH VOLTAGE CONVERTER, IGNITING THE OXYGEN AND FUEL GAS AT THE FIRE CONE, CAUSING AN EXPLOSION IN THE TUNNEL SYSTEM 109.

While this invention has been described with reference to the described embodiments, this description is not to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

1. A burrowing rodent extermination device comprising:
a remote control panel including a gas mixing chamber;
a gas flow valve connected to the gas mixing chamber;
an ignition switch connected to the remote control panel and a power source;
a first hose including a first end connected to a fuel gas tank and the first hose including a second end connected to the gas mixing chamber;
a second hose including a first end connected to an oxygen tank and the second hose including a second end connected to the gas mixing chamber;
a third hose having a length in the range of 1.5 to 30.5 meters long feet, the third hose connected between a downstream end of the gas flow valve and an injector;
an ignition wire connected between the ignition switch and a high voltage converter attached to the injector; and
a spark emitter positioned in the fire cone of the injector, the spark emitter connected to the ignition switch and a high voltage converter.

2. The burrowing rodent extermination device of claim 1 further comprising:
a first mixing valve connected between an upstream end of the gas mixing chamber and the second end of the first hose; and
a second mixing valve connected between the upstream end of the gas mixing chamber and the second end of the second hose.

3. The burrowing rodent extermination device of claim 2 wherein the first mixing valve, the second mixing valve and the gas mixing chamber further comprise a gas welding torch.

4. The burrowing rodent extermination device of claim 1 further comprising a gas flow valve operation lever connected to a lid of the remote control panel, the gas flow valve operation lever cooperatively operative with a flow control actuator connected to the gas flow valve.

5. The burrowing rodent extermination device of claim 1 further comprising an ignition circuit cutout switch connected to the ignition switch and cooperatively operative with the gas flow valve.

6. The burrowing rodent extermination device of claim 1 further comprising:
a regulator connected between the mixing chamber and the propane tank; and
a regulator connected between the mixing chamber and the oxygen tank.

7. The burrowing rodent extermination device of claim 1 wherein the fuel gas tank further comprises a propane tank.

8. A burrowing rodent extermination device comprising:
a remote control panel including a gas mixing chamber;
a gas flow valve connected to the gas mixing chamber;
an ignition switch connected to the remote control panel and a power source;
a first hose including a first end connected to a regulator, the regulator connected to a fuel gas tank and the first hose including a second end connected to a mixing valve connected to the gas mixing chamber;
a second hose including a first end connected to a regulator, the regulator connected to an oxygen tank and the second hose including a second end connected to a mixing valve connected to the gas mixing chamber;
a third hose having a length in the range of 1.5 to 30.5 meters long feet, the third hose connected between an outlet end of the gas flow valve and an injector;
an ignition wire connected between the ignition switch and a high voltage converter attached to the injector;
gas flow valve operation lever connected to a lid of the remote control panel, the gas flow valve operation lever cooperatively operative with a flow control actuator connected to the gas flow valve;
an ignition circuit cutout switch connected to the ignition switch and cooperatively operative with the gas flow valve; and
a spark emitter positioned in the fire cone of the injector, the spark emitter connected to the ignition switch and a high voltage converter.

9. The burrowing rodent extermination device of claim 8 wherein the first mixing valve, the second mixing valve and the gas mixing chamber further comprise a gas welding torch.

10. The burrowing rodent extermination device of claim 1 wherein the fuel gas tank further comprises a propane tank.

11. A method for controlling a population of burrowing rodents including the steps of:
connecting a first hose between a fuel gas tank and a gas mixing chamber contained in a remote control panel of a device for controlling the population of burrowing rodents, the remote control panel located at a first position;
connecting a second hose between an oxygen tank and the gas mixing chamber;
connecting a third hose between a gas flow valve connected to a downstream end of the gas mixing chamber and an injector of the device for controlling the population of burrowing rodents, the injector located at a second position in the range of 5 to 100 feet from the first position;
connecting an ignition wire between an ignition switch attached to the remote control panel and a high voltage converter connected to the injector;
opening a hole at a dirt mound of a burrowing rodent, the hole connecting to a tunnel system;
placing a fire cone end of the injector into the hole opened in the fresh dirt mound of the burrowing rodent;
opening the gas flow valve for 30-60 seconds, injecting a controlled ratio of oxygen and fuel gas into the tunnel system;
closing the gas flow valve; and
engaging the ignition switch connected to the high voltage converter, igniting the oxygen and fuel gas at the fire cone, causing an explosion in the tunnel system.
